(19) United States
(12) Patent Application Publication
(10) Pub. No.: US 2013/0199996 A1
(43) Pub. Date: Aug. 8, 2013

(54) GROUND WATER REMEDIATION USING HUMATE ENHANCED AEROBIC COMETABOLISM

(71) Applicants: Brian B. Looney, Aiken, SC (US); M. Hope Lee, Idaho Falls, ID (US); Chris M. Yeager, Los Alamos, NM (US)

(72) Inventors: Brian B. Looney, Aiken, SC (US); M. Hope Lee, Idaho Falls, ID (US); Chris M. Yeager, Los Alamos, NM (US)

(21) Appl. No.: 13/366,814

(22) Filed: Feb. 6, 2012

(51) Int. Cl. C02F 3/00; C02F 3/02; C02F 103/06

(52) U.S. Cl. 210/610

(57) ABSTRACT

A process of bioremediation of chlorinated solvents is provided. The process involves stimulating a microbial biomass of bacteria having oxygenase activity through the introduction of natural organic matter, such as a soluble humate, into a contaminated aquifer. The resulting increase in bacterial biomass results in the cometabolism of chlorinated solvents. The process allows remediation of a contaminated aquifer under aerobic conditions.

### STATEMENT AS TO RIGHTS TO INVENTIONS MADE UNDER FEDERALLY SPONSORED RESEARCH AND DEVELOPMENT

This invention was made with Government support under Contract No. DE-AC09-08SR22470 awarded by the United States Department of Energy. The Government has certain rights in the invention.

### FIELD OF THE INVENTION

This invention is directed towards the removal from aquifers of trichloroethene (TCE) and other chlorinated solvents.

### BACKGROUND OF THE INVENTION

Traditional in situ bioremediation treatment methods for chlorinated solvents in groundwater have utilized reagents that deplete oxygen and stimulate anaerobic degradation. While the use of such technologies can achieve bioremediation of chlorinated solvents such as TCE, the anaerobic nature of the treatment conditions result in a significant loss of water quality. In essence, the aquifer using anaerobic treatment conditions is converted into a putrid reactor system with a resulting severe degradation of water quality. The reduced water quality limits subsequent potential uses of the aquifer, particularly for systems in which the groundwater is naturally aerobic and normally contains dissolved oxygen. Microbially mediated chlorinated solvent degradation occurs naturally in aerobic groundwater systems, but at slow rates, allowing the contaminated zone to spread over large distance unless the degradation rates are enhanced. Accordingly, there remains a need in the art to develop efficient bioremediation techniques which can achieve remediation goals of chlorinated solvents and do so without degrading water quality.

### SUMMARY OF THE INVENTION

It is one aspect of at least one of the present embodiments to provide an aerobic bioremediation technique to treat trichloroethene and related chlorinated solvents present in groundwater.

It is yet another aspect of at least one of the present embodiments to use natural organic matter (NOM), in the form of a humates and similar compounds, to enhance the in situ aerobic degradation rates of chlorinated organic solvents found in groundwater.

It is yet a further aspect of at least one embodiment of the present invention to provide for an in situ bioremediation method directed to chlorinated solvents in which aerobic cometabolism may be used to treat large groundwater contamination plumes.

It is a further aspect of at least one embodiment of the present invention to stimulate natural process conditions in aerobic settings so as to achieve enhanced bioremediation of chlorinated solvents without degrading useful qualities of the associated aquifer.

It is yet a further aspect of at least one embodiment of the present invention to provide an in situ bioremediation method in which NOM additives are analogs of naturally occurring organic matter and when added to groundwater provide for an additive having longevity for aerobic degradation of chlorinated organic solids present in the ground water.

It is yet a further aspect of at least one of the present embodiments to provide a process for decreasing the concentration of chlorinated solvents in an aquifer comprising the steps of: introducing into an aquifer contaminated with chlorinated solvents an effective amount of NOM; stimulating the growth of microorganisms which metabolize the introduced humate and stimulating production of enzyme systems that cometabolize chlorinated solvents within these organisms, monitoring the system to document performance and sustainability, introduction of an additional supply of NOM if the desired level of microbial activity is not maintained, and, repeating the steps until a targeted reduction in chlorinated solvents is achieved.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is a graph setting forth potassium humate sorption equilibrium at various pH values.

FIG. 2 is a schematic diagram showing various cometabolism steps and pathways for chlorinated solvents.

FIG. 3 is a schematic diagram illustrating the process steps of injecting a soluble humate into groundwater where the humate stimulates naturally occurred microorganisms to bring about a cometabolic degradation of TCE and other chlorinated solvents.

FIG. 4 sets forth stimulation of microbial biomass following humate amendments as measured by qPCR analysis of 16S rRNA gene abundance.

FIG. 5 sets forth the stimulation of microorganisms that metabolize aromatic hydrocarbons at various natural organic carbon supplement levels as analyzed qPCR enumeration of the phenol oxygenase gene.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

According to the present invention, it has been established that soluble humates and other forms of soluble, slow degrading “aromatic rich” NOM may be used as an amendment to contaminated groundwater having chlorinated organic solvents. The amendments have been found to stimulate naturally occurring bacteria, which have inherent, broad-specificity oxygenases. The increase in oxygenase-bearing bacterial species and oxygenase activity brought about by the amendment of NOM, such as soluble humate, significantly increases the degradation of chlorinated organic solvents by oxygenase activity. Importantly, the soluble humate provides a persistent organic source which does not require frequent replenishment. The soluble humate is slowly metabolized by the bacterial community resulting in enhanced, but sustainable, rates of chlorinated solvent degradation. The humate amendment has been found to accelerate degradation of chlorinated organic solvents in aerobic environment and maintain desirable aquifer water quality.

The present invention lends itself to contaminated oligotrophic aquifers that typically have a total bacterial cell density of between 10³ to 10⁵ cells per mL of water. Some of the native bacteria metabolize NOM including aromatic (carbon ring) carbon structures via oxidative catabolism whereby oxygenase enzymes are used to insert oxygen into a substrate. Because these enzymes have evolved to catalyze the oxidation of multiple growth substrates, a number of them will fortuitously oxidize TCE and other chlorinated solvents. Adding natural organic matter having aromatic structures to the system supports an increased biomass of oxygenase-containing bacteria and stimulates expression of TCE-degrading oxygenases, which together results in a concomitant increase in cometabolic degradation rates.

By increasing the natural organic matter through the addition of soluble humate, the increased biomass and increased amount of oxygenase activity has been found to increase the cometabolic degradation rate to levels that will allow environmental remediation goals for chlorinated solvent abatement to be met.

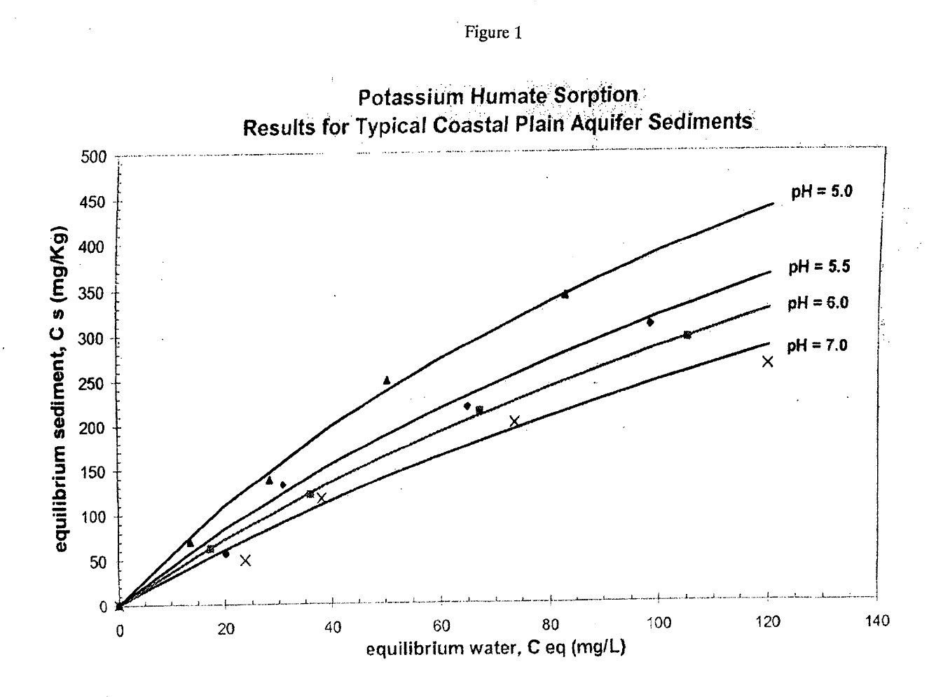

As set forth in FIG. 1, a typical aquifer water source may be supplemented with significant levels of an introduced soluble humate so as to achieve an enhanced level of soluble aromatic carbon supply. In accordance with this invention, it has been demonstrated that microbial densities may be increased by 10 to 50 fold through the addition of reasonable amounts (economically feasible for large-scale TCE plumes) of commercially prepared NOM. One important aspect of the use of a soluble humate is that the humate is a persistent carbon source and does not need the frequent replenishment that is typically required in other bioremediation approaches. While some prior art approaches require nutritional supplementation on a weekly or greater basis, the nature of the soluble humate is such that additional amendments of soluble humate may be needed on an interval of several years. The soluble humate, being an aromatic carbon source, specifically stimulates members of the bacterial community that have oxygenase capabilities. The increase in oxygenase organisms allows for a cometabolism of chlorinated solvents along with naturally occurring aromatic carbon sources.

The process of using a soluble humate amendment also allows the aquifer to be maintained in an aerobic condition because of the slow degradation rates of the persistent NOM carbon source. This enables the microbial community to maintain oxidative processes including chlorinated solvent degradation. Additionally, post remediation uses of the aquifer are greatly enhanced. Further, degradation of water quality of non-contaminated areas is avoided where an otherwise anaerobic treated plume may migrate and impact water quality of adjacent regions.

One useful soluble humate is potassium humate, which has been utilized in the present studies. Additional substrates that will result in useful cometabolism include other aromatic carbon ring structures such as toluene and simple carbon or nitrogen compounds including methane, propane, or ammonia. Potassium humate is deemed a beneficial additive given its commercial availability and low cost. NOM that may be used include potassium humate ligosulfonates, fulvic acid, soluble cellulose derivatives, terpenes/terpenoids, soluble unstaturated organic polymers, and aromatic organic polymers.

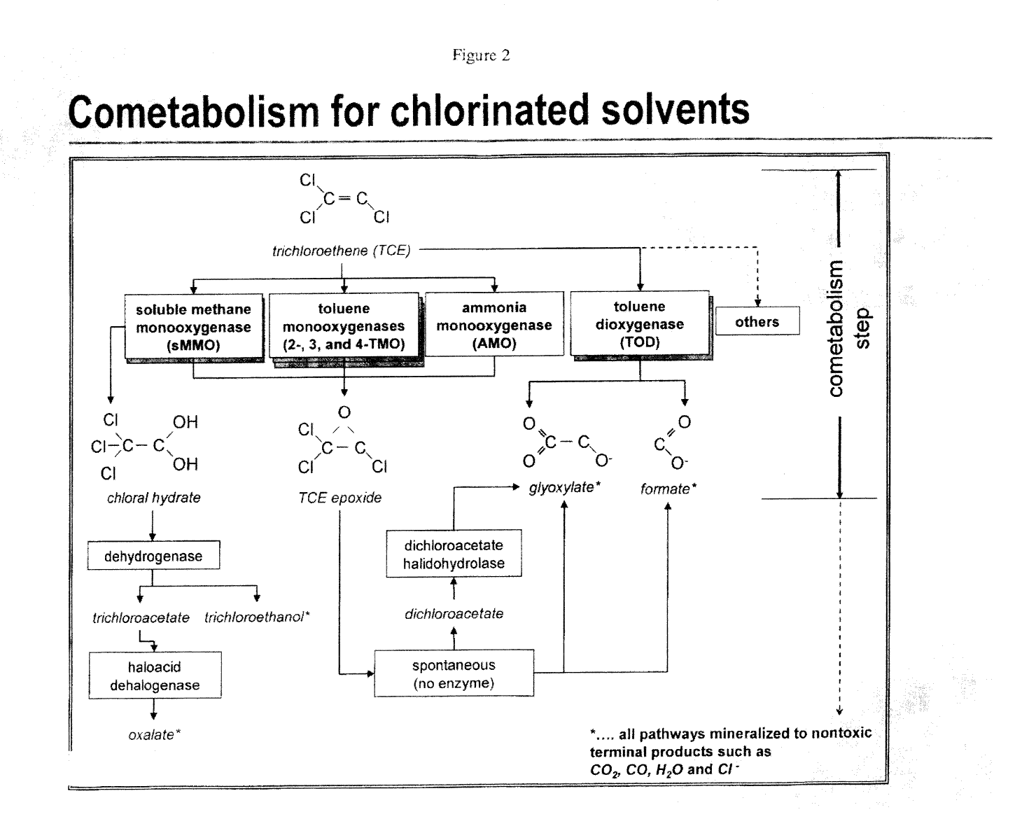

FIG. 2 depicts several representative, oxygenase-catalyzed degradation pathways for TCE. As indicated, there are a plurality of useful cometabolism steps that are supported by natural microbial communities in an oligtrophic environment. It has been found that by stimulating the population density of the microbial community with the use of a soluble humate, the level of desired oxygenase activity increases which results in the cometabolism of trichloroethene and other chlorinated solvents. Such process steps occur in an aerobic environment and do not require or generate anaerobic conditions.

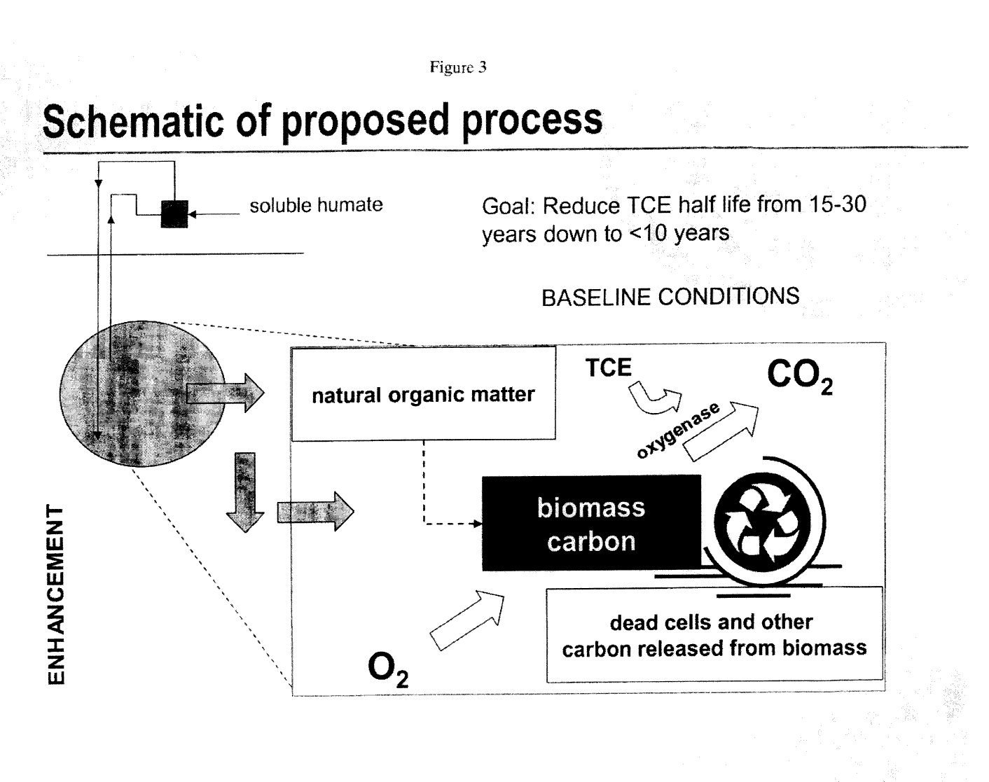

As best seen in reference to FIG. 3, the introduction of a soluble humate within a contaminated plume will supplement the existing natural organic matter resulting in an increase in microbial biomass. The soluble humate preferentially stimulates microbial community members having inherent oxygenase capabilities. While the oxygenase capabilities are primarily directed towards naturally occurring aromatic carbon compounds, the enzymes associated with the metabolism of aromatic carbon will also degrade various chlorinated solvents such as those identified in FIG. 2.

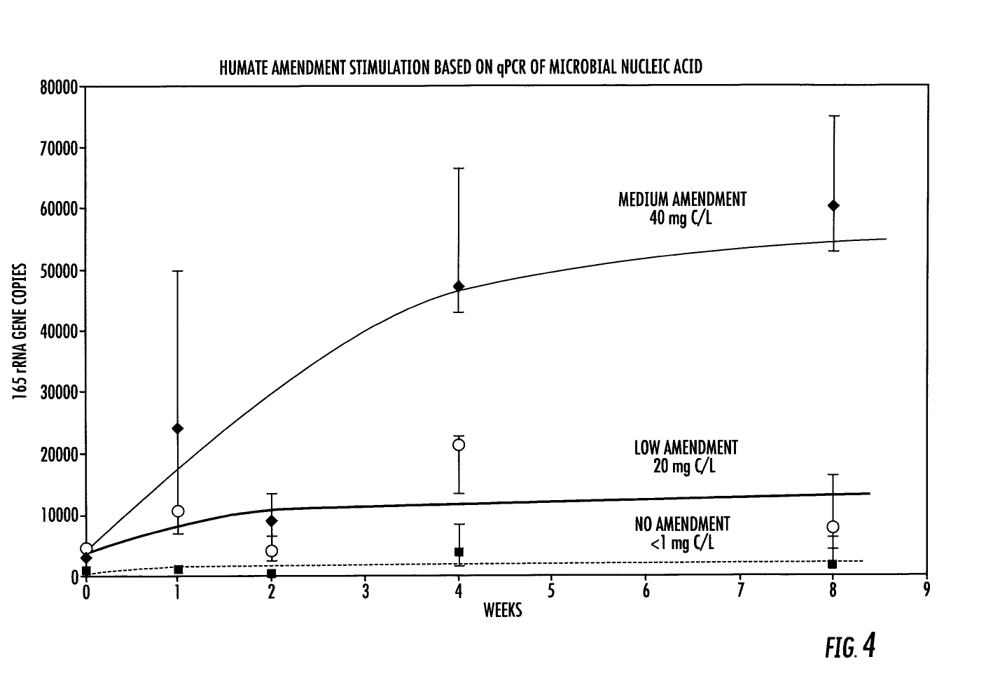

As set forth in reference to FIG. 4, humate amendment stimulates microbial growth. As seen by the data, increasing amounts of humate correlates with an increase in the number of microorganisms present which in turn migates higher metabolic activity.

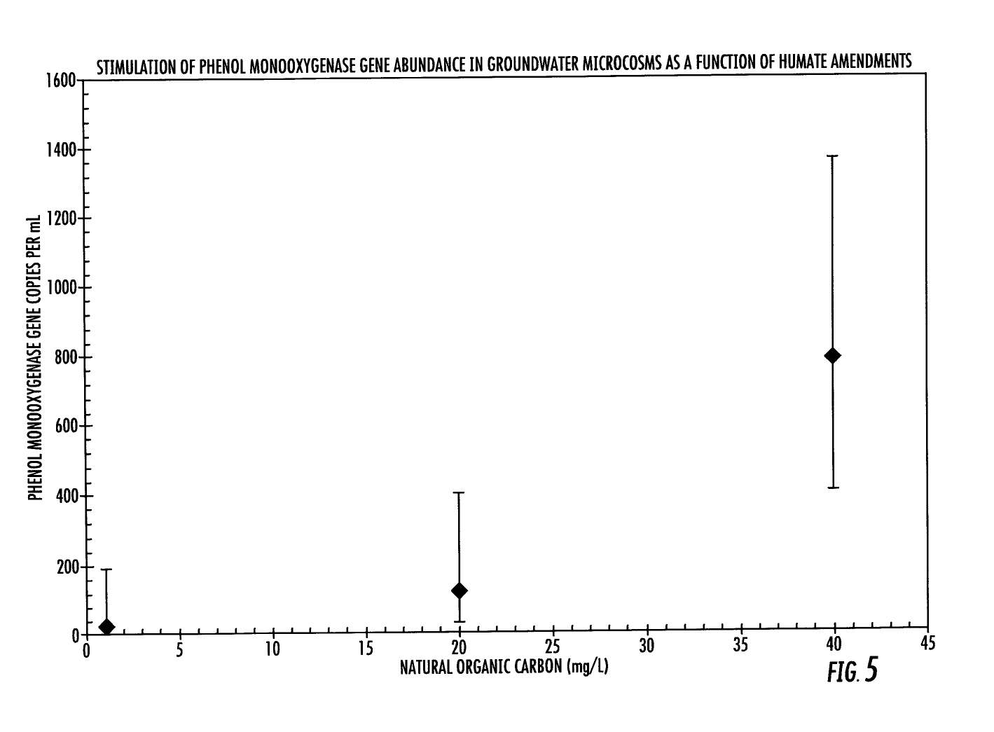

As further seen in reference to FIG. 5, a more targeted method of assessing oxygenase activity is through phenol mono-oxygenase gene copy quantification. As set forth in FIG. 5, the levels of phenol mono-oxygenase (a known TCE degrading enzyme) genes in the groundwater microcosm increase as the natural organic carbon levels are increased.

The experiments described herein were conducted in the laboratory using groundwater collected from an aerobic aquifer having moderate levels of trichloroethylene contaminants of approximately 500 ug/L. The bacteria observed in this experiment were present in the aquifer and responded to the added amendments. The gene copy analysis was performed using qPCR (quantitative polymerase chain reaction).

The laboratory test studies measured the absorption of NOM in typical sedimentary solids within an aerobic aquifer and involved a sandy sediment with less than 20% clay and a low organic content. Experiments were conducted using a Langmuir equation that identified an approximate maximum amount of humate absorption. In the studies set forth herein, the maximum absorption was calculated to be 1,100 mg humate carbon per Kg of soil. From these results it was approximated that 1,900 Kg of humate carbon would be required to treat a cylindrical geometry having a radius of 10 meters, a height of 10 meters with an active porosity of 0.12 and having a sediment property of bulk density of 1.8 grams/cm³. Once deployed into the concentrated target cylinder, NOM leaching from the “loaded” sediments substantially extends the range of microbial stimulation to the downgradient groundwater in the order of hundreds of meters. Based on the laboratory results and knowledge of groundwater conditions, an impact area of greater than 400 m² (20 m×200 m) would receive dissolved NOM concentrations exceeding 50 mg humate carbon per liter over an extensive period, measured in decades. Based upon the laboratory data, contaminant degradation rates would increase by approximately a factor of 10 in the impact area.

In the examples described above, amendment costs would be approximately $35,000 to bring about the long-term increase in contamination degradation rates. At the time of deployment, NOM concentrations and microbial counts would be periodically measured and observed such that additional microbial stimulation by added NOM could be carried out when a threshold concentrations of NOM drops below 50 mg carbon per liter in the impact zone.

The above-described process is believed useful for selected types of aquifers where a passive remediation system operating over an interval of several years is appropriate. The present process lends itself toward the in situ biodegradation of chlorinated solvents within groundwater making use of naturally occurring bacterial populations. The remediation process provides for a low cost treatment option which maintains the desired aerobic quality in the groundwater. Additional advantages include the persistent nature of the amendment of a soluble humate which avoids the frequent replenishment necessitated by other aerobic or anaerobic treatment approaches. By the selection of soluble humates as an introduced amendment, a contaminated aquifer may be treated more quickly than would occur naturally, be maintained in an aerobic state, and does not require labor or capital-intensive intervention once an initial introduction of a soluble humate is accomplished.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, or in part. Therefore, the spirit and scope of the appended claims should not be limited to the description of the preferred versions contained therein.

That which is claimed:

1. A process for decreasing the concentration of chlorinated solvents in an aquifer comprising the steps of:
introducing into an aquifer contaminated with chlorinated solvents an effective amount of natural organic matter (NOM);
stimulating the growth of microorganisms which metabolize the introduced NOM and concomitantly degrade chlorinated solvents present within the aquiferr;
monitoring the microbial population using enzyme activity probes, qPCR and similar microbial assays;
maintaining a desired level of microbial activity through the periodic introduction of an additional supply of NOM; and,
repeating said steps until a targeted reduction in chlorinated solvents is achieved.

2. The process according to claim 1 wherein said NOM is potassium humate.

3. The process according to claim 1 wherein said effective amount of NOM further includes materials selected from the group consisting of ligosulfonates, fulvic acid, soluble cellulose derivatives, terpenes/terpenoids, soluble unstaturated organic polymers, soluble aromatic organic polymers, potassium humate, and combinations thereof.

4. A process for decreasing the concentration of chlorinated solvents in an aquifer comprising steps of:
introducing into an aquifer contaminated with chlorinated solvents an effective amount of natural organic matter (NOM);
maintaining an aerobic environment within said aquifer;
stimulating the growth of aerobic microorganisms which metabolize introduced NOM said microorganisms further degrading chlorinated solvents present within the aquifer;
maintaining a desired level of microbial activity through the periodic introduction of an additional supply of natural organic matter; and
repeating such steps into a targeted reduction in chlorinated solvents is achieved.

5. The process according to claim 4 wherein said NOM is potassium humate.

6. The process according to claim 4 wherein said effective amount of NOM further includes materials selected from the group consisting of ligosulfonates, fulvic acid, soluble cellulose derivatives, terpenes/terpenoids, soluble unstaturated organic polymers, soluble aromatic organic polymers, potassium humate, and combinations thereof.

7. The process according to claim 4 comprising the additional step of monitoring the microbial population using enzyme activity probes, qPCR in similar microbial assays.
